(19) United States
(12) Patent Application Publication
(10) Pub. No.: US 2014/0052457 A1
(43) Pub. Date: Feb. 20, 2014

(54) Method for Treatment Billing

(71) Applicants: Steven Tover, Hasmonaim (IL); Daniel Shapiro, Ottawa (CA); Stanley Shapiro, Sudbury (CA); Brian Dressler, Sudbury (CA)

(72) Inventors: Steven Tover, Hasmonaim (IL); Daniel Shapiro, Ottawa (CA); Stanley Shapiro, Sudbury (CA); Brian Dressler, Sudbury (CA)

(21) Appl. No.: 13/588,536

(22) Filed: Aug. 17, 2012

(51) Int. Cl. G06Q 50/22

(52) U.S. Cl. 705/2

(57) ABSTRACT

A method of billing is disclosed comprising the steps of the server billing at least one treatment for a client by a device by means of a billing unit, a treatment computer in communication with the device requesting access of the device using an access code, the device granting access for a treatment if the access code is valid and blocking access if the access code is not valid, and treating the client using the device when access to the device is granted. Further disclosed is a method of billing comprising the steps of a service provider locating a device at a clinic, the clinic providing a treatment to a client, the clinic billing a payer, the payer paying a treatment fee to the clinic, and the clinic paying a subset of the treatment fee to the service provider.

### FIELD

The invention relates to a method of billing clients for treatments with a medical device.

### BACKGROUND

The medical device industry is comprised of surgical, cardiovascular, home healthcare, general medical and other invasive and non-invasive devices. In the transcranial Direct Current Stimulation (tDCS) space, sales models include the sale of devices through a supply chain, the sale of disposable peripherals such as sponges and electrodes, and the sale of services such as treatments, maintenance and repair. Existing approaches to selling non-invasive medical devices includes distribution and direct sales. In both cases of distribution and directs sales, payment is made to the seller from direct purchase of equipment, rental of equipment, or rental and lending of equipment, with or without the option to purchase.

In the prior art, distribution is generally multi-tiered or single tier. With reference to FIG. 7, in the multi-tiered distribution model the manufacturer 251 sells through a third party called a distributor 252. The distributor 252 then assumes the responsibility to sell to the customer 254. Distributors 252 are usually paid from the proceeds of sales and take a percentage of the amount paid to the manufacturer. Generally, the manufacturer will share in some of the marketing efforts through a contribution of co-marketing funds that is negotiated between the manufacturer 251 and distributor 252. In addition, the manufacturer 251 will usually provide technical support and training 240 to the distributor 252.

Single tier distribution as described in FIG. 10 occurs when the distributor has its own sales force that sells directly to the customer. Multi-tiered distribution with a service provider, as shown in FIG. 8, occurs when the distributor sells through resellers. These resellers can be categorized by geography or industry (area of expertise).

Leveraging local medical distributors to establish a local supply chain is one way to bridge the gap between experience and opportunity. There are many benefits for medical device companies leveraging local medical distributors in emerging markets. Because of their familiarity with the social and political landscape, local distributors can provide easier market access, manage financial risk, and work with regulatory bodies.

Working with local distributors can present some challenges however, including a risk of diluting company brand, minimal transparency into operations, and lack of customer relationships. There is also the challenge of managing relationships in a manner that is consistent with US ethics laws. Furthermore, there can be minimal loyalty across regions because medical distributors sell competing products in different countries/regions.

Direct sales is an approach where the manufacturer establishes a sales force to work directly with a targeted customer base. In the direct sales model, such as depicted in FIG. 9, the manufacturer supports sales with marketing, training, and customer support. One benefit to the manufacturer in a direct sales model is that the manufacturer owns the customer relationship and has a direct line to better understanding the customers' needs. An additional benefit is that the manufacturer does not share its revenue with the distributor.

### SUMMARY

A method of billing for treatment by a device is disclosed comprising the steps of the server billing at least one treatment for a client by a device by means of a billing unit, a treatment computer in communication with the device requesting access of the device using an access code, the device granting access for a treatment if the access code is valid and blocking access if the access code is not valid, and treating the client using the device when access to the device is granted.

In an embodiment, the method further comprises the steps of a treatment computer requesting an access code for a device as a client from a server; and the server providing an access code for the device as a client to the treatment computer. In a further embodiment the access code provided to the treatment computer is encrypted.

In an additional embodiment the method further comprises the step of the device forgetting the access code once a client is treated. The at least one treatment may be a block of treatments having a number of available treatments for a client.

In a further embodiment the device is a group of devices within a clinic. The method may further comprise the step of the device reporting treatment data to the server. The treatment data may comprise timestamps for commencing treatment and terminating treatment and duration and level of applied voltage and current.

An embodiment of the method further comprises the step of the device reporting device condition information to the server. In an embodiment of the method at least one treatment given is counted against a block of treatments. A further embodiment comprises the step of the device reducing the number of available treatments for the client by one after treating the client.

An embodiment of the method further comprises adding at least one treatment to the number of available treatments for the client when the server bills the at least one treatment by means of a billing unit. The device may have unique Bluetooth unit name for identification within the clinic.

Also disclosed is a method of providing medical device treatments comprising the steps of a service provider locating a device at a clinic, the clinic providing a treatment to a client, the clinic billing a payer, the payer paying a treatment fee to the clinic, and the clinic paying a subset of the treatment fee to the service provider. In a further embodiment the service provider owns the device, and/or maintains the device in good working order.

A system for billing for treatment with a medical device is disclosed, comprising a server having electronically stored therein access codes, at least one medical device for treating a client, the device electronically activated and a treatment by the device made accessible by an access code, at least one treatment computer in communication with the server and the device, for controlling the medical device and receiving and electronically storing access codes from the server, and a billing unit in communication with the server for billing a client, wherein the server receives treatment information from the medical device.

### DESCRIPTION OF FIGURES

FIG. 1 is a diagram showing a method of billing per-treatment, at the time of treatment;

FIG. 2 is a diagram showing a further embodiment of the method of billing per-treatment, at the time of treatment;

FIG. 3 is a diagram showing a method of billing per block of N treatments, at a billing interval;

FIG. 4 is a diagram showing a method of billing in advance per block of N treatments;

FIG. 5 is an example of a subset of medical device treatment data stored on the server;

FIG. 6 is a diagram showing an embodiment of the method of billing treatments;

FIG. 7 is a diagram showing an example in the prior art of a multi-tiered distribution model;

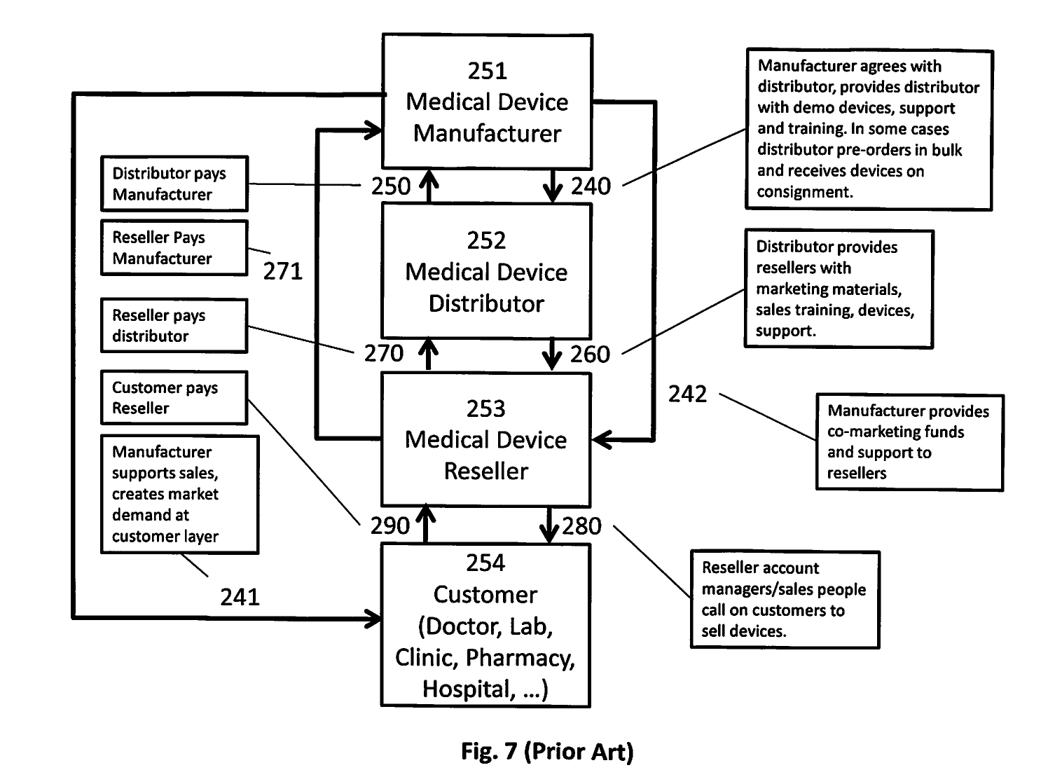

FIG. 8 is a diagram showing an example in the prior art of a multi-tiered distribution model with a service provider;

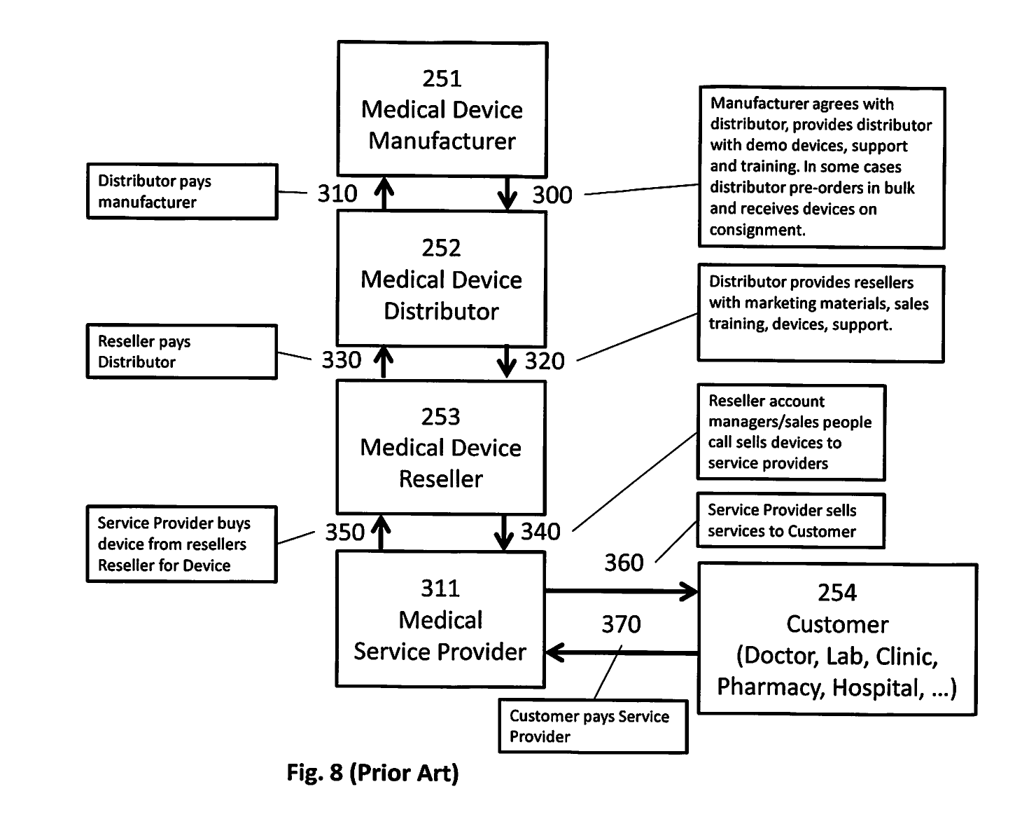

FIG. 9 is a diagram showing an example in the prior art of a direct sales;

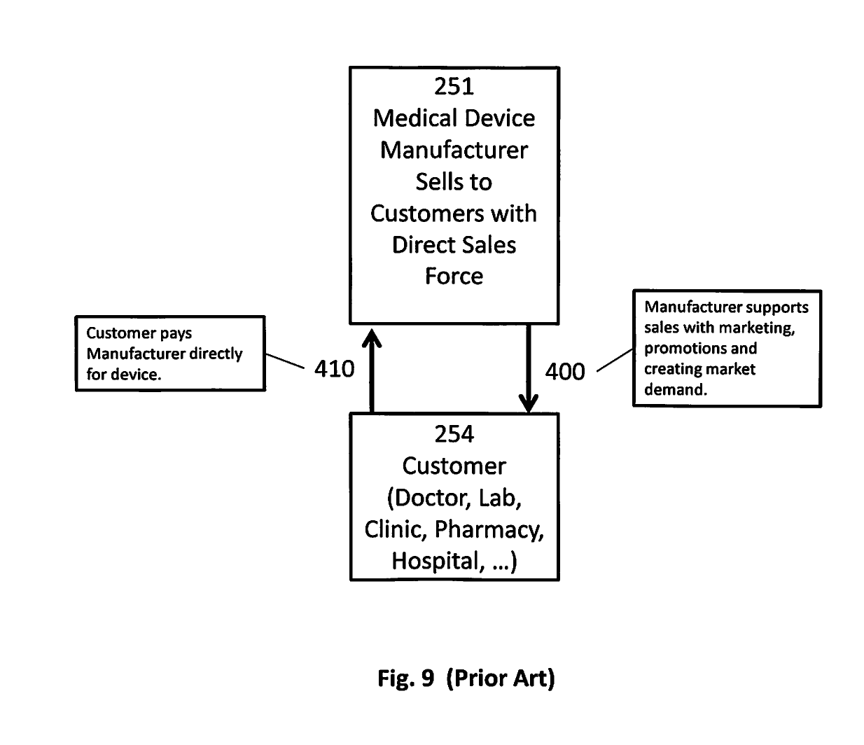

FIG. 10 is a diagram of an example in the prior art of a single-tier distribution model; and

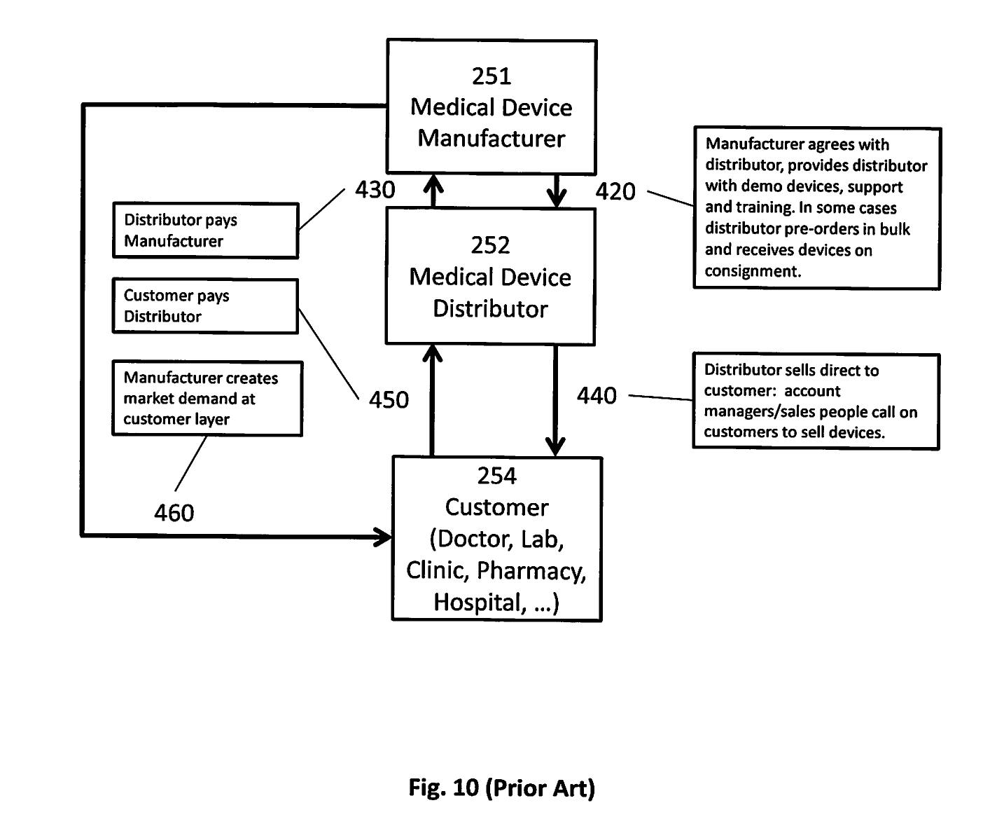

FIG. 11 is a diagram of an example of a medical device labeled with ergonomic naming scheme.

FIG. 12 depicts an embodiment of a hardware configuration.

### DETAILED DESCRIPTION

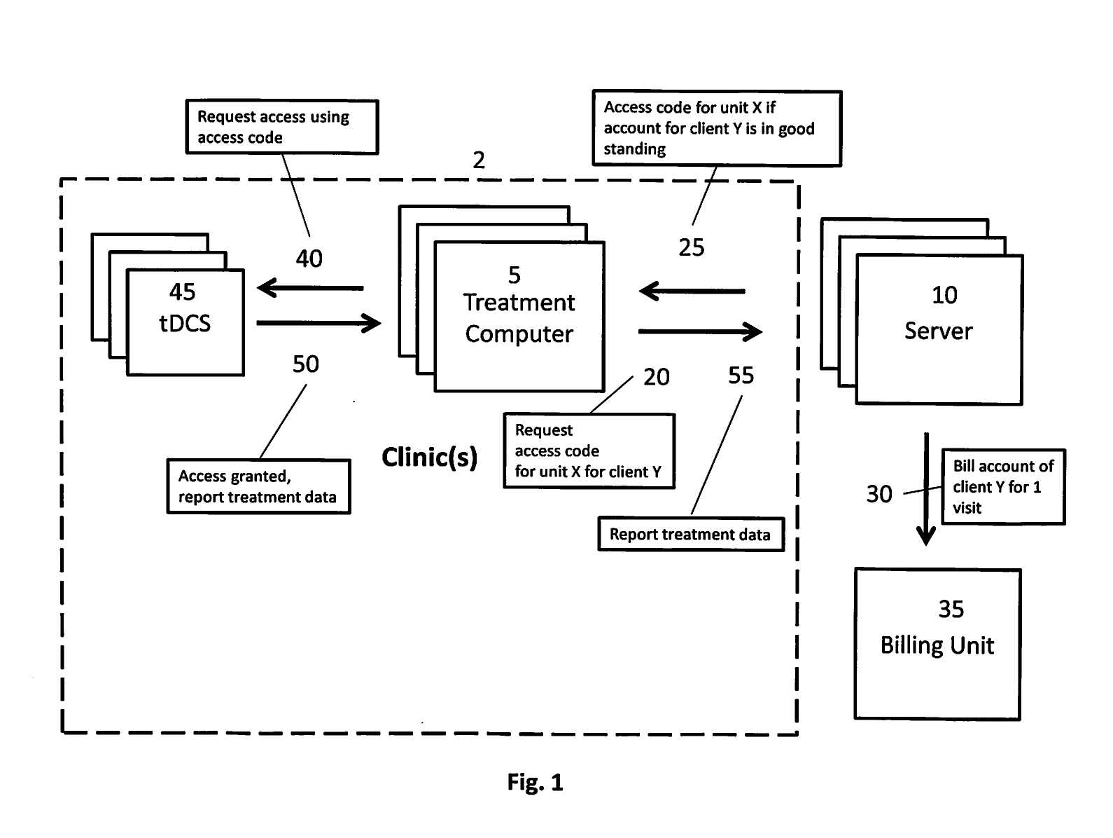

With reference to FIG. 1, a method for billing on a per-treatment basis, at the time of the treatment, wherein the medical device treatment is administered only if the account is in good standing, is described. The clinic 2 systems are contained within the stippled box, and these systems are generally on the premises of the clinic or clinics where the treatment is performed. These systems include a medical device 45 such as the transcranial Direct Current Stimulation (tDCS) unit which provides the treatment to the client or patient (not shown) and treatment computer 5, which may be any computer that is capable of controlling the treatment delivered by the tDCS unit 45 including for example a PC, tablet or smartphone, and may be within the tDCS unit 45 itself. In one embodiment the treatment is controlled by the treatment computer 5, and in another embodiment the treatment is controlled by the medical device 45 itself. In one embodiment the device 45 is electronically activated. The in-clinic medical device operator of 5 (not shown) is not aware of the access code as the authentication is performed without operator intervention on the part of the clinic beyond requesting the treatment itself. Server 10 may be located at a central administration office and has the capability of connecting to and instructing many treatment computers 5 simultaneously, and maintains the treatment history and data for individual medical device 45 units. Data transferred to the server 10 includes but is not limited to physiological measurements such as impedance and timing information used to form a record of the treatment. This data can be used for longitudinal diagnostic medicine purposes, for the generation of patient treatment records such as charts and graphs, and can be used to generate billing information. Each entry into the server may be encrypted and is associated with a unique identification code. The server 10 is connected to a billing unit 35, residing either on the server 10 or within a separate billing system, which maintains client accounts for patients and/or clinics, and adjusts balances according to treatments and payments. The billing unit may interface with Electronic Funds Transfer (EFT) systems, may interface with government or private insurance servers for filing billing information. For example York-Med™ billing software for filing Ontario Health Insurance claims.

The medical device 45 may be a tDCS device which has a housing, a battery pack, a microcontroller and two or more electrodes, wherein the microcontroller controls the delivery of electrical power through the electrodes which, in treatment, are placed on a client's head or body to allow a current to pass through the client's brain. The device 45 is in communication with the treatment computer 5. Other devices may include Transcranial Magnetic Stimulation (TMS), Cranial Electrical Stimulation (CES), Microcurrent Therapy (MCT), Iontophoresis, Transcutaneous Electrical Nerve Stimulation (TENS), and other electrotherapy medical devices.

With further reference to FIG. 1, in step 20 the treatment computer 5 authenticates with the server 10 using a userid and password, and once authenticated requests of the server 10 the access code for a particular medical device 45, in this case tDCS unit “X” 5 for a particular client Y. Specifying the tDCS unit 45 is important as the server maintains accounts for many medical devices units. If the account for client Y, which is accessible from the server 10, is in good standing, then at step 25 the access code for unit X for client Y is provided by the server 10 to the treatment computer 5. The server 10 maintains a database table with a list of access codes it can transmit. If the client is not verified as being in good standing, because the client has not made timely payments, or the client is otherwise prohibited from providing treatment, then the server 10 does not provide an access code to the treatment computer 5, and the treatment computer 5 will not receive access to the tDCS unit 45. The treatment computer 5 grants access to the client if the access code is valid and blocks access if the access code is not valid, or if no access code is sent. Whether or not access is granted, the treatment computer authenticates with the medical device 45 using an authentication code provided by the server 10. The treatment computer may also authenticate with the medical device by means of authentication through a physical connection such as a wired connection. If the client is authenticated as in good standing, the server 10 sends data to the billing unit 35, which bills the account of client Y for 1 visit at step 30. In step 40 the treatment computer 5 requests access to the transcranial direct current stimulation (tDCS) medical device unit 45 using the access code which is verified by the tDCS unit 45. Authentication allows temporary access by the clinic to the tDCS device 45 in order to complete a single treatment session. At step 50 the device 45 verifies the access code and grants access, as well as reporting treatment data. The treatment computer 5 reports any usage of the device 45 to the server 10.

Device units 45 may be viewed as one account by the server 10 or as a group based on a common clinic 2, or across clinics, for example. This enables an authenticated client to receive treatment at any of the medical device units 45 in a given clinic 2.

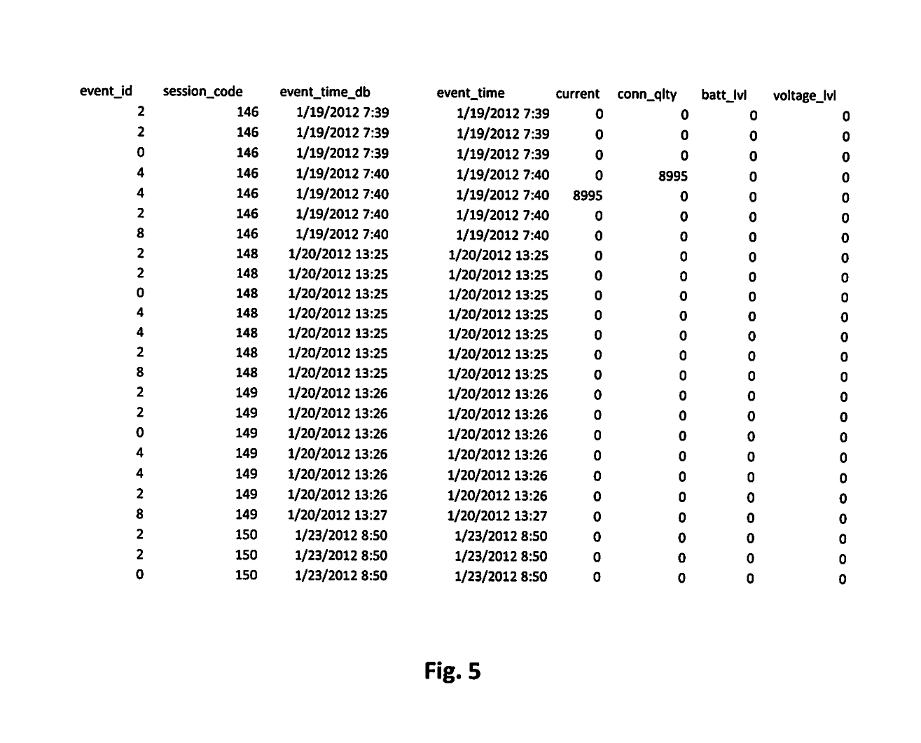

In step 55, the treatment computer 5 reports treatment data to the server 10 as the patient is being treated. Treatment data may include patient specific information, and treatment events such as session started, session paused, command acknowledged, session stopped, stimulation current descending, session stop command sent, emergency stop command sent, pause command sent, descent current command sent, session resuming, ascend current command sent, current measured, voltage measured, impedance measured, clinic identity, session identity, timestamp, lost Bluetooth connection, re-established Bluetooth connection, several types of electrode errors, impedance warning, high impedance detected, and several other treatment parameters. An example of some treatment data that is transmitted to the server 10 from the medical device 45 is provided in FIG. 5.

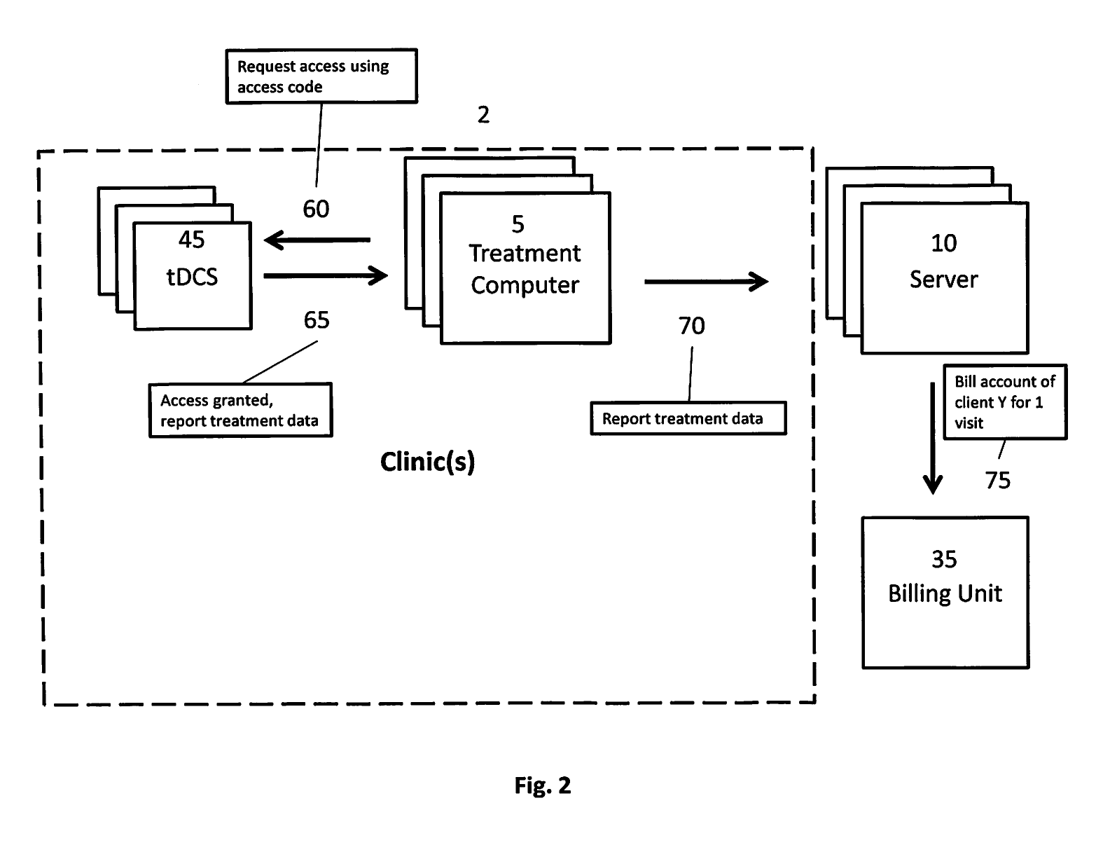

With reference to FIG. 2, a method for billing per-treatment at the time of treatment, regardless of account status, is described. This is not a generalization of FIG. 1, rather it is an alternative billing method and method for data transfer. At step 60, the treatment computer 5 requests access of the medical device 45 using the access code built into the medical software on the treatment computer 5. This embodiment does not limit access to the device 45 at the server 10 level, but does ensure that the person applying the treatment with the device is an authorized user by requiring a username and password. At step 65, access is granted by the medical device 45 and treatment data is reported to the treatment computer 5. At step 70, the treatment computer 5 reports the treatment data to the server 10, and at step 75 the server sends a command containing the clinic account number to the billing unit 35 to bill the account of client Y for 1 visit.

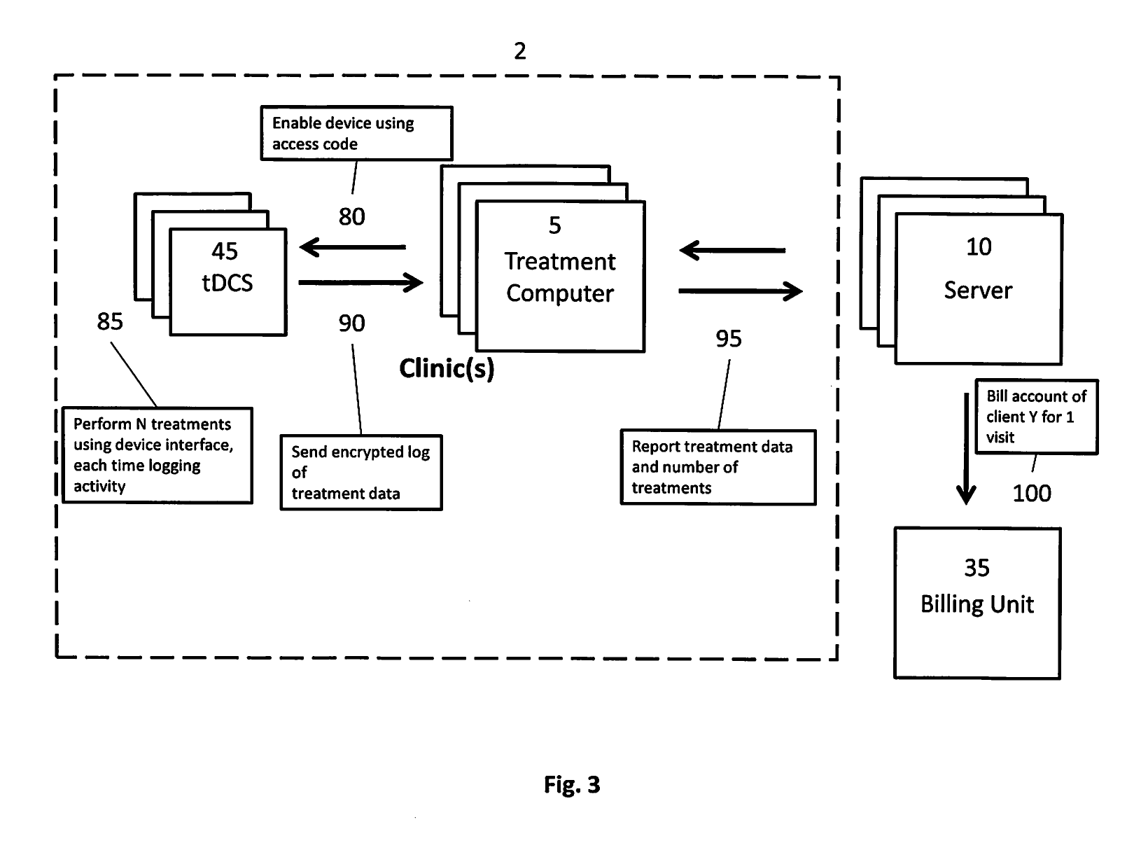

With reference to FIG. 3, a method of per-block treatments billing over a billing interval, regardless of account status, is described. The client Y is purchasing N treatments (a block) at a pre-determined billing interval. The benefit in purchasing multiple treatments in a block is that an Internet connection is not required to verify each treatment individually by the server 10, rather access codes corresponding to the block are sent by the server 10 in a pool, and may be used without further authentication from the server 10. In another embodiment, there is no pool of access codes, rather one or more access codes are reused and have counters associated therewith to determine how many times they have been used, or a countdown timer that is reset on payment with the number of treatments paid for (N). In step 80, the treatment computer 5 communicates with the medical device 45 to enable the medical device 45 using the access codes generated at the time of the medical device 45 factory configuration and stored in the server database. When a block of treatments is purchased, a pool of access codes corresponding to the block is sent to the treatment computer 5, which may access treatments for clients based on this pool of access codes. In step 85, clinic is free to administer as many treatments to their clients as the number of authenticated treatments remaining in the block. Step 85 shows the clinic using the medical device 45 to perform a number of (N) treatments at a time of their choosing, using the buttons on the medical device 45 or the treatment computer 5. During any of the N treatment administrations in step 85, the medical device 45 logs treatment data for the clinic, and periodically communicates the logs to the server 10, through the treatment computer 5. In Step 90, an encrypted version of the aforementioned log of treatment data is sent by the medical device 45 to the treatment computer 5. The treatment computer 5 in turn reports treatment data and the number of treatments given to the server 10 at step 95. In one embodiment, the pool of access codes (N—the number of treatments given) may reside within the treatment computer 5, which decrements the pool after each treatment. Where access codes are reused, the medical device 45 ‘forgets’ the access code, removing it from memory once the treatment is administered. Thereafter, at step 100 the server 10 instructs the billing unit 35 to bill the account of client Y for 1 visit. The billing unit 35 updates the server 10 with information regarding successful payment by clients. Steps 90, 95, and 100 are repeated for each of the N treatments described in step 85.

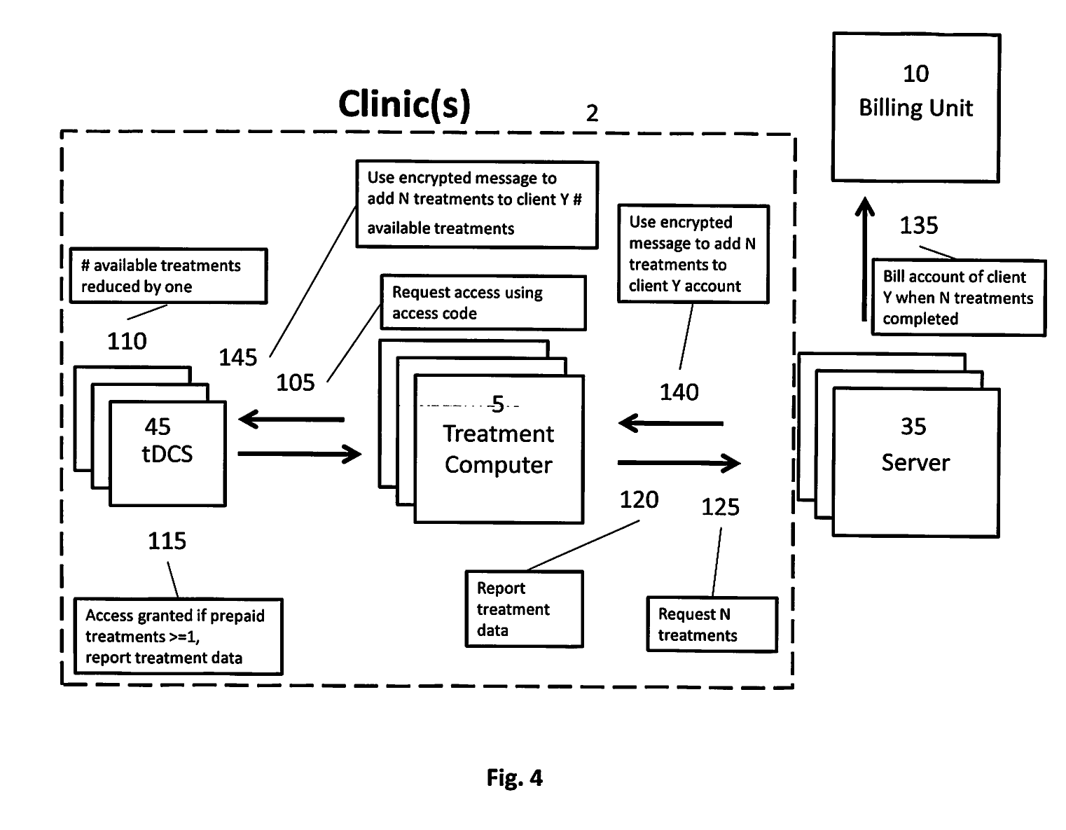

With reference to FIG. 4, an advance of a block of a number of (N) treatments is purchased by client Y, and client Y is treated only while prepaid treatments remain. At step 105, the treatment computer 5 requests access of the medical device 45 using an access code taken from a pool associated with the block of treatments. At step 110 the number of available treatments is reduced by one by the medical device 45. The medical device 45 also deletes the access code from its memory so a new access code from the pool is required for the next treatment, or the same access code if access codes are being reused. At step 115 access is granted by the medical device 45 if the number of prepaid treatments remaining is greater than one, and treatment data is reported to the treatment computer 5. At step 120, the treatment computer reports treatment data to the server 10.

In order to replenish the account with a block of N treatments, the treatment computer 5 requests N treatments of the server 10 at step 125. The server 10 instructs the billing unit 35 to bill the account of client Y when N treatments are completed at step 135. At step 140 the server 10 uses an encrypted message sent to the treatment computer 5, to add N treatments to the number of available treatments for client Y stored in the server 10 and verified by the treatment computer 5 and medical device 45 before each communication session is initiated between the medical device 45 and the treatment computer 5 as well as the server 10. Access codes for the block of N treatments are sent to the treatment computer 5 in order to permit access to the device 45, or prevent access where invalid codes or no codes at all are sent.

With reference to FIG. 5, an example of data that may be stored on the server 10 is shown. Each record is a treatment event, which contains data such as a unique record ID, and Event ID which describes the nature of the record. According to best engineering practices for reduction of database size and improvement of database access time, the events logged in the server are not stored as text and instead they are stored as unique numerical identifiers. A separate lookup table is maintained on the server for converting these event IDs into textual labels representing events such as “Treatment Started”. The session code links each event with a session. Each session may have multiple events, for example the medical device engaged, treatment has commenced, and treatment has terminated. A time stamp is recorded for each event. The current field records the amplitude of the treatment current in a tDCS session. A record of the connection quality is also maintained using a numerical scale. Different medical devices have different parameters of interest to be stored in the server. The battery level of the medical device is monitored so that timely recharging may be effected, and so that the manufacturer can monitor the effectiveness of the battery longitudinally. Finally, the voltage level of each event is recorded. The duration and level of the applied current and voltage allows the server 10 to determine the treatment program being followed. In one embodiment of the invention, the server is a separate entity from the treatment computer, but it is also possible that the server is implemented on the treatment computer itself. In general, the server maintains medical records and the treatment computer maintains a validated copy of the medical device control software. Treatment parameters can be entered into the device directly or via the treatment computer. Besides for the treatment data described above, records in the server may also contain information about patients in clinical trials, patient questionnaires, and patient and clinic access codes for accessing information via a web interface.

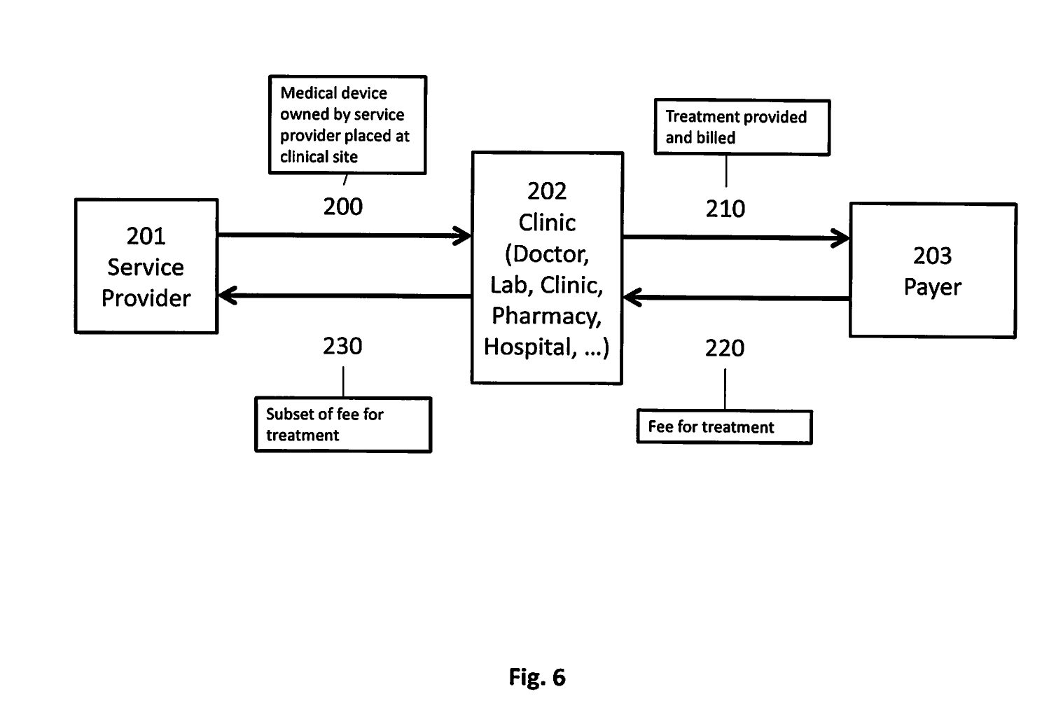

With reference to FIG. 6, an overview of the service model for medical devices is shown. There are three parties in the transaction: i) the service provider 201, which provides the medical device as well as services such as medical record generation and billing, and may typically be either a manufacturer or distributor; ii) the clinic 202 where medical treatment using the device is administered to the patient; and iii) the payer 203, which pays for the patient's treatment, and may be the patient him or herself or an insurance company. The service provider 201 owns the medical device (not shown), and places the device at clinical site in step 200. The clinic 202 administers a treatment to the patient at step 210 and bills the treatment to the payer 203. At step 220 the payer pays the fee for the treatment to the clinic 202, and at step 230 a subset of the fee for treatment to the clinic 202 is paid to the service provider 201. In one embodiment the service provider 201 owns the medical device (not shown) and maintains it in good working order.

This series of methods permits the medical device 45 to be provided without charge, or on a rental basis, to a clinic 2 wherein clients are only billed for use of the medical device. This would enable clinics and other medical facilities to conserve operating capital for their day-to-day operations rather than spending it on equipment, while the clinic receives the benefit of the medical device and can offer its use to clients or patients The clinic does not risk outlay of capital on a medical device that is not in demand by its clients, and is able to benefit from a risk-free trial period. The medical device provider ensures that the medical devices are operational at all times, and repairs or replaces any defective devices immediately to ensure the maximum benefit to clients. In typical medical device systems, security and privacy breaches often result from the incorrect configuration of encryption protocols, and the selection of weak passwords. For the medical device system described, encryption and authentication are built into the system from the ground up, and so there is a much lower chance of a security breach or a breach of patient privacy. Authorization mechanisms are set in the factory, with high-entropy long passwords. Channel encryption is configured by the manufacturer instead of the device operator, ensuring a higher level of security and a lower error rate than typical medical device systems.

On the other hand, the medical device provider benefits where the medical device is in demand, and may receive remuneration in excess of the price for the device. Through regulation of the price for the service, the medical device provider limits price undercutting by others owning the medical devices. The relationship between the medical device provider and clinic may be governed by a license so the provider may exert sufficient control over the quality of the treatments. Treatment data is gathered by the server of the provider and allows the provider to improve the product and understand its use by clientele to properly appreciate the business realities, such as anticipated demand, etc.

In the prior art medical device manufacturers also sell through distribution and direct sales, but are focused on the research market, limiting the volume of units sold. These manufacturers tend to sell one device at a time. The customer base is usually a research lab, university or other non-clinical institution.

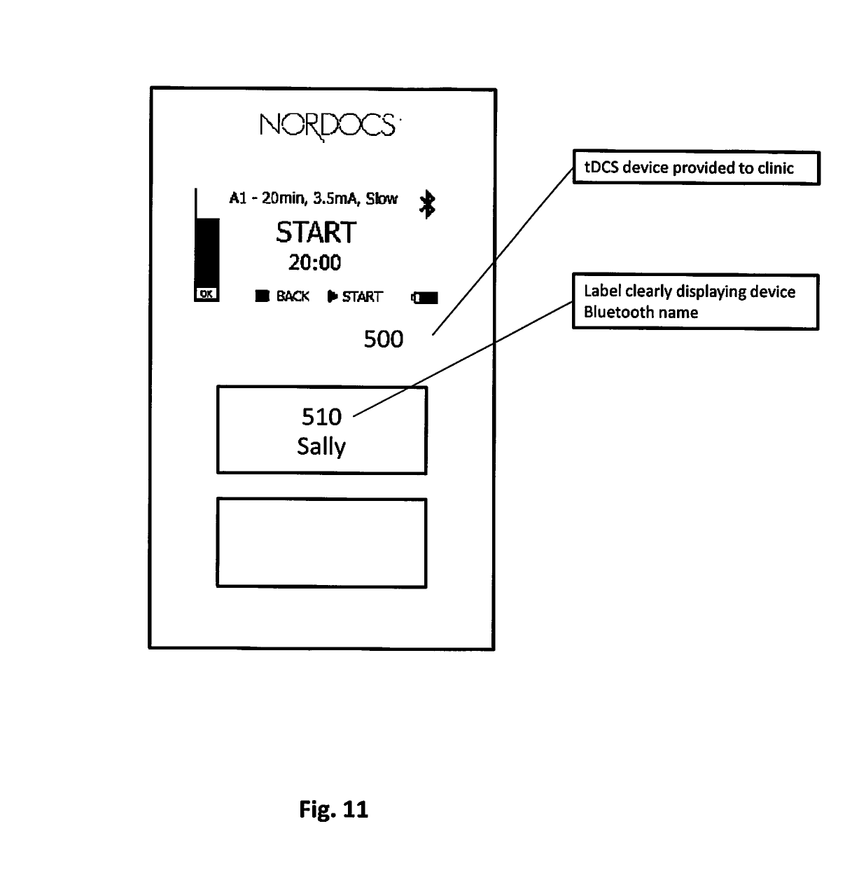

With reference to FIG. 11, the ability to assign medical devices such as tDCS units 45 unique and meaningful Bluetooth unit names is described. Names such as Johnny, Barbara, or Sally, are assigned from an easily remembered and pronounced scheme, as a complement to the use of serial number identification such as ND-01-030203. The label for the assigned name 510 may be printed onto or adhered to the front of the device 500. This approach helps to gain acceptance of the device from the staff, and can prevent clinic staff from confusing one device for another.

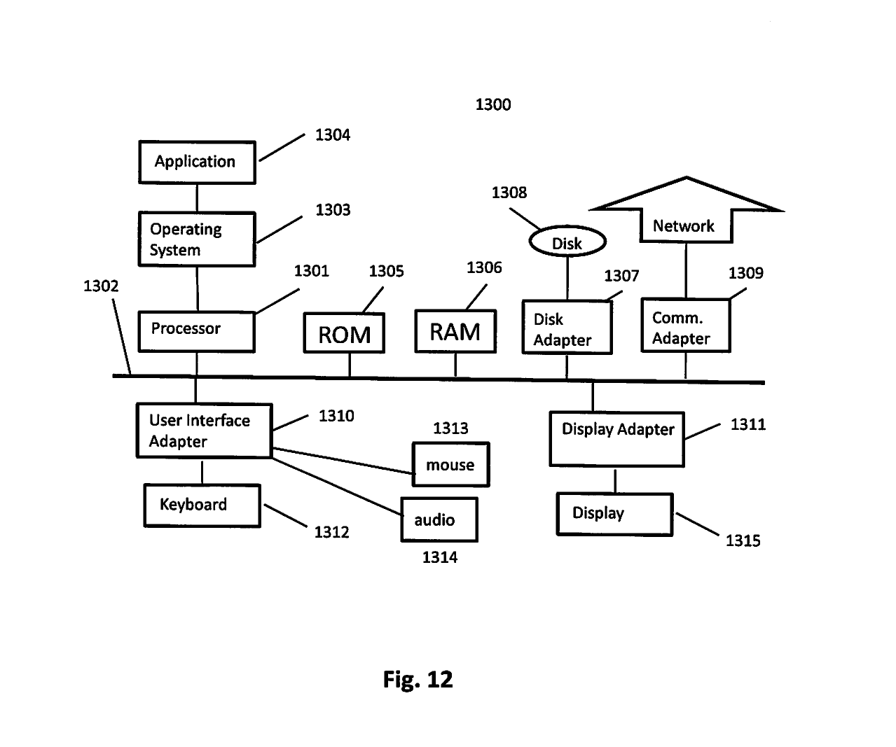

FIG. 12 depicts an embodiment of a hardware configuration of a system 1300 which is representative of a hardware environment for practicing the present invention, in particular the treatment computer 5, the server 10 and the billing unit 35. Referring to FIG. 12, computer system 1300 has a processor 1301 coupled to various other components by system bus 1302. An operating system 1303 may run on processor 1301 and provide control and coordinate the functions of the various components of FIG. 12. An application 1304 in accordance with the principles of the present invention may run in conjunction with operating system 1303 and provide calls to operating system 1303 where the calls implement the various functions or services to be performed by application 1304. Application 1304 may include, for example, an application for creating and linking 3D spatial objects with dynamic data and visualizing said objects as discussed above.

Referring again to FIG. 12, read-only memory (“ROM”) 1305 may be coupled to system bus 1302 and include a basic input/output system (“BIOS”) that controls certain basic functions of computer system 1300. Random access memory (“RAM”) 1306 and disk adapter 1307 may also be coupled to system bus 1302. It should be noted that software components including operating system 1303 and application 1304 may be loaded into RAM 1306, which may be computer system's 1300 main memory for execution. Disk adapter 1307 may be an integrated drive electronics (“IDE”) adapter that communicates with a disk unit 1308, e.g., disk drive.

Computer system 1300 may further include a communications adapter 1309 coupled to bus 1302. Communications adapter 1309 may interconnect bus 1302 with an outside network (not shown) thereby allowing computer system 1300 to communicate with other similar devices.

I/O devices may also be connected to computer system 1300 via a user interface adapter 1310 and a display adapter 1311. Keyboard 1312, mouse 1313 and audio (speaker) 1314 may all be interconnected to bus 1302 through user interface adapter 1310. A display monitor 1315 may be connected to system bus 1302 by display adapter 1311. In this manner, a user is capable of inputting to computer system 1300 through keyboard 1312 or mouse 1313 and receiving output from computer system 1300 via display 1315 or speaker 1314.

Many modifications and other embodiments of the invention will come to the mind of a person skilled in the art having the benefit of the teachings presented in the foregoing description and associated drawings. Therefore, it is understood that the invention is not to be limited to the specific embodiment disclosed, and that modifications and embodiments are intended to be included within the scope of the appended claims.

1. A method of billing for treatment, comprising the steps of:
a. the server billing at least one treatment for a client by a device by means of a billing unit;
b. a treatment computer in communication with the device requesting access of the device using an access code;
c. the device granting access for a treatment if the access code is valid and blocking access if the access code is not valid; and
d. treating the client using the device when access to the device is granted.

2. The method of claim 1 further comprising the steps of:
a. a treatment computer requesting an access code for a device from a server; and
b. the server providing an access code for the device to the treatment computer.

3. The method of claim 2 wherein the access code provided to the treatment computer is encrypted.

4. The method of claim 1, further comprising the step of the device forgetting the access code once a client is treated.

5. The method of claim 1, wherein the at least one treatment is a block of treatments having a number of available treatments for a client.

6. The method of claim 1, wherein the device is a group of devices within a clinic.

7. The method of claim 1, further comprising the step of the device reporting treatment data to the server.

8. The method of claim 7 wherein the treatment data comprises timestamps for commencing treatment and terminating treatment and duration and level of applied voltage and current.

9. The method of claim 1 further comprising the step of the device reporting device condition information to the server.

10. The method of claim 1, wherein at least one treatment given is counted against a block of treatments.

11. The method of claim 5, further comprising the step of the device reducing the number of available treatments for the client by one after treating the client.

12. The method of claim 5, further comprising adding at least one treatment to the number of available treatments for the client when the server bills the at least one treatment by means of a billing unit.

13. The method of claim 1 wherein the device has unique Bluetooth unit name.

14. A method of billing for treatment comprising the steps of:
a. a service provider locating a device at a clinic;
b. the clinic providing a treatment to a client with the device;
c. the clinic billing a payer;
d. the payer paying a treatment fee to the clinic; and
e. the clinic paying a subset of the treatment fee to the service provider.

15. The method of claim 14 wherein the service provider owns the device.

16. The method of claim 14 wherein the service provider maintains the device in good working order.

17. A system for billing for treatment with a medical device, comprising:
a. a server having electronically stored therein access codes;
b. at least one medical device for treating a client, the device electronically activated and a treatment by the device made accessible by an access code;
c. at least one treatment computer in communication with the server and the device, for controlling the medical device and receiving and electronically storing access codes from the server; and
d. a billing unit in communication with the server for billing a client,
wherein the server receives treatment information from the medical device.
